(19) United States
(12) Patent Application Publication
(10) Pub. No.: US 2022/0127292 A1
(43) Pub. Date: Apr. 28, 2022

(54) METHOD FOR PRODUCING AMIDINATE METAL COMPLEX

(71) Applicant: GAS-PHASE GROWTH LTD., Tokyo (JP)

(72) Inventors: Hideaki MACHIDA, Tokyo (JP); Masato ISHIKAWA, Tokyo (JP); Hiroshi SUDOH, Tokyo (JP)

(73) Assignee: GAS-PHASE GROWTH LTD., Tokyo (JP)

(21) Appl. No.: 17/304,395

(22) Filed: Jun. 21, 2021

(30) Foreign Application Priority Data
Oct. 22, 2020 (JP) 2020-177613

(51) Int. Cl. C07F 15/02; C07F 13/00; C07F 3/02; C07F 15/04; C07F 1/08; C07F 1/00; C07F 5/00

(52) U.S. Cl. CPC C07F 15/025; C07F 13/005; C07F 3/02; C07F 5/003; C07F 1/08; C07F 1/005; C07F 15/045

(57) ABSTRACT

To provide a method for producing an amidinate metal complex which is represented by [R¹—N—C(R³)—N—R²]nM in cost saving and simple manner.

A method for producing an amidinate metal complex represented by [R¹—N—C(R³)—N—R²]nM including:
a first step in which R³X is reacted with a metal Li in a solvent to obtain R³Li solution with LiX suspended therein;
a second step in which the R³Li solution with LiX existing therein is reacted with R¹—N═C═N—R² to obtain a [R¹—N—C(R³)—N—R²]Li solution with the LiX suspended therein;
a third step in which the [R¹—N—C(R³)—N—R²]Li solution with the LiX existing therein is reacted with MX to obtain an amidinate metal complex solution, represented by the [R¹—N—C(R³)—N—R²]nM, with the LiX suspended therein; and
a fourth step for removing the LiX in the solution obtained by the third step.

### TECHNICAL FIELD

The present invention relates to a method for producing an amidinate metal complex.

### BACKGROUND ART

For example, the Atomic Layer Deposition (ALD) Method is used for depositing a metal film in the field of semiconductor. But a metal compound (metal complex) of all kinds cannot be used in the ALD method. For example, a β-diketone metal complex has a steam pressure of a certain degree. With such a chemical compound, however, it was difficult to deposit a metal film or a nitride metal film by means of the ALD method. In a case where a N, N′-dialkylamidinate metal complex was used, the aforementioned problem could be solved. When the deposition of a film was performed by the ALD method using the N, N′-dialkylamidinate metal complex, a metal film and a nitride metal film could be obtained. In a case where a copper amidinate complex was applied to the Supercritical Deposition Method, a thin copper film close to bulk copper could be deposited.

The N, N′-dialkylamidinate metal complex can be synthesized by the following method. It can be obtained by reacting N, N′-dialkylamidinate lithium with metal halide. The metal halide is commercially available. On the other hand, the N, N′-dialkylamidinate lithium is not commercially available.

The N, N′-dialkylamidinate lithium can be synthesized by the following method.

One of the synthesis methods follows below. The N, N′-dialkylamidinate lithium is obtainable by reacting a n-butyllithium solution with N, N′-dialkyl amidine. The n-butyllithium is commercially available. On the other hand, the N, N′-dialkyl amidine is not commercially available. Further, the N, N′-dialkyl amidine has poor preservation stability.

The other synthesis method follows below. The N, N′-dialkylamidinate lithium is obtainable by reacting alkyllithium with N, N′-dialkyl carbodiimide. The N, N′-dialkyl carbodiimide is commercially available as a peptide synthesis reagent. Methyllithium and n-butyllithium are commercially produced and commercially available. On the other hand, the alkyllithium other than the above is not commercially produced or commercially available.

For example, to synthesize a N, N′-dialkylpropion amidinate metal complex or a N, N′-dialkylbutane amidinate metal complex, ethyllithium or n-propyllithium is essential. But they are not commercially available.

An ethyllithium (or n-propyllithium) solution can be obtained in such a manner that lithium is reacted with ethyl chloride (or n-propyl chloride) and thereafter lithium chloride as an unnecessary by-product is removed therefrom.

R—Cl+2Li→RLi+LiCl

More specifically, synthesis of the N, N′-dialkylpropion amidinate metal complex (or the N, N′-dialkylbutane amidinate metal complex) includes a first step for synthesizing ethyllithium (or n-propyllithium) and removing lithium chloride therefrom, a second step for synthesizing N, N′-dialkylamidinate lithium, and a third step for synthesizing a N, N′-dialkylpropion amidinate metal complex and removing the lithium chloride therefrom. This method requires complicated operations and high cost while it provides low productivity.

### CITATION LIST

### Patent Literature

[PATENT LITERATURE 1] U.S. 2013/016861 A1

### SUMMARY OF INVENTION

### Technical Problem

A purpose of the present invention is to solve the above-mentioned problem. More specifically, a purpose of the present invention is to provide a method for producing an amidinate metal complex represented by {[R¹—N—C(R³)—N—R²]nM} at low cost with a simple process.

### Solution to Problem

The inventors have conducted intensive studies for solving the above problem.

As a result, the inventors found that, in the step for synthesizing the amidinate metal complex,

for example, it is also possible to synthesize the N, N′-dialkylpropion amidinate lithium (or N-N′-dialkylbutane amidinate lithium) by reacting ethyllithium (or n-propyllithium) with N, N′-dialkyl carbodiimide even without removing the lithium chloride generated in the step of synthesizing ethyllithium (or n-propyllithium),

and it is further possible to synthesize the N, N′-dialkylpropion amidinate metal complex (or N, N′-dialkylbutane amidinate metal complex) by reacting metal chloride with N, N′-dialkylpropion amidinate lithium (or N-N′-dialkylbutane amidinate lithium) even without removing the lithium chloride existing in a reaction system.

Further, it was found that, upon the reaction, the lithium chloride (LiX) as a vice-generative production does not give any serious adverse effect to the synthetic reaction.

Here, in a case where a product material A1 generated in a reaction step (a) is used in the subsequent reaction step (b), a vice-generative production A2 generated in the reaction step (a) is normally removed. This is because there are many cases that the vice-generative production A2 inhibits the reaction subsequently performed in the reaction step (b).

In the reaction, the lithium chloride (vice-generative production) was normally removed. As a result of the studies of the inventors, it is found that the lithium chloride (LiX) as the vice-generative production does not give any serious adverse effect to the synthetic reaction. Such a teaching could be obtained that it is not necessary to preliminary remove the vice-generative production generated in the previous reaction of the reaction provided that no serious adverse effect is given.

The present invention was made based on the above-described knowledge.

The Present Invention Proposes

a method for producing an amidinate metal complex represented by {[R¹—N—C(R³)—N—R²]nM},

wherein R³X is reacted with a metal Li within a solvent to obtain a R³Li solution with the LiX suspended therein, the R³Li in the solution with the LiX existing therein is reacted with R¹—N═C═N—R² to obtain a [R¹—N—C(R³)—N—R²]Li solution with the LiX suspended therein, the [R¹—N—C(R³)—N—R²]Li in the solution with the LiX existing therein is reacted with MX to obtain a [R¹—N—C(R³)—N—R²]nM solution with the LiX suspended therein and, thereafter, the LiX in the [R¹—N—C(R³)—N—R²]nM solution is removed.

The R¹ and R² represent an alkyl group whose carbon number is 2 to 4 or an alkyl group having Si whose carbon number is 2 to 4. The R³ represents —C₂H₅ or —C₃H₇. The n represents 2 or 3. The M represents Mg, Ca, V, Cr, Mn, Fe, Co, Ni, Cu, Ag, or Ru. The X represents Cl, Br, or I. The X of the LiX may be identical to or different from the X of the MX.

The present invention proposes a method for producing an amidinate metal complex, wherein the reaction of the R³Li with the R¹—N═C═N—R² is performed in a state where the LiX is substantially left in the R³Li solution.

The present invention proposes the method for producing an amidinate metal complex, wherein the reaction of the R³Li with the R¹—N═C═N—R² is performed without performing any special process for removing the LiX suspended in the R³Li solution.

The present invention proposes the method for producing an amidinate metal complex, wherein the reaction of the [R¹—N—C(R³)—N—R²]Li with the MX is performed in a state where the LiX is substantially left in the [R¹—N—C(R³)—N—R²]Li solution.

The present invention proposes the method for producing an amidinate metal complex, wherein the reaction of the [R¹—N—C(R³)—N—R²]Li with the MX is performed without performing any special process for removing the LiX suspended in the [R¹—N—C(R³)—N—R²]Li solution.

The present invention proposes the method for producing an amidinate metal complex, wherein the removal of the LiX in the [R¹—N—C(R³)—N—R²]nM solution is performed by replacing a solvent in the [R¹—N—C(R³)—N—R²]nM solution with a hydrocarbon-based solvent.

The present invention proposes the method for producing an amidinate metal complex, wherein the removal of the LiX is performed by one or two or more operations selected from the group consisting of filtration, centrifugal separation, decantation, and distillation.

The present invention proposes the method for producing an amidinate metal complex, wherein the process from the reaction of the R³X with the metal Li to the reaction of the [R¹—N—C(R³)—N—R²]Li with the MX is performed in the same container.

The present invention proposes the method for producing an amidinate metal complex, wherein the reaction from the generation of the R³Li to the generation of the [R¹—N—C(R³)—N—R²]nM is performed in the same container.

The present invention proposes the method for producing an amidinate metal complex, wherein the R¹—N═C═N—R² is N, N′-diisopropylcarbodiimide or N, N′-di-tert-butylcarbodiimide.

The present invention proposes the method for producing an amidinate metal complex, wherein the MX is at least one chemical compound selected from the group consisting of YCl₃, MnCl₂, FeCl₂, CoCl₂, NiCl₂, CuCl, AgCl, YBr₃, MnBr₂, FeBr₂, CoBr₂, NiBr₂, CuBr, AgBr, YI₃, MnI₂, FeI₂, CoI₂, NiI₂, CuI, and AgI.

The present invention proposes the method for producing an amidinate metal complex, wherein the [R¹—N—C(R³)—N—R²]nM is used for depositing a M-based film.

### Advantageous Effect of Invention

Easy production of the [R¹—N—C(R³)—N—R²]nM is realized. The low producing cost is achieved.

### BRIEF DESCRIPTION OF DRAWINGS

### Description of Embodiments

The present invention is directed to a method for producing [R¹—N—C(R³)—N—R²]nM. The chemical compound {[R¹—N—C(R³)—N—R²]nM} is a chemical compound to be used for depositing a M-based film. The M-based film is a M metal film, a nitride M metal film, or an oxide M metal film. The M-based film is not limited thereto. For example, the M-based film is a carbonized M metal film. The chemical compound is an amidinatc metal complex used in the deposition, specially, performed by the ALD method. The method for producing [R¹—N—C(R³)—N—R²]nM includes a first step for reacting R³X with a metal Li in a solvent to obtain a R³Li solution with LiX suspended therein. The method includes a second step for reacting the R³Li solution with the LiX existing (being left; being suspended) therein with R¹-N═C═N—R² to obtain a [R¹—N—C(R³)—N—R²]Li solution with the LiX existing (being left: being suspended) therein. The method includes a third step for reacting the [R¹—N—C(R³)—N—R²]Li solution with the LiX existing (being left: being suspended) therein with MX to obtain an amidinate metal complex solution represented by the [R¹—N—C(R³)—N—R²]nM with the LiX existing (being left: being suspended) therein. The method includes a fourth step for removing the LiX in the solution obtained by the third step. The R¹ and R² represent an alkyl group whose carbon number is 2 to 4 or an alkyl group having Si whose carbon number is 2 to 4. The R³ is —C₂H₅ or —C₃H₇. Then is 2 or 3. The M is Mg, Ca, V, Cr, Mn, Fe, Co, Ni, Cu, Ag, or Ru. The X of the LiX and the X of the MX may be the same or may be different from each other.

The first step is represented by the following reaction formula (1).

R³X+2Li→R³Li+LiX (1)

The second step is represented by the following reaction formula (2).

R³Li+LiX+R¹—N═C═N—R²→[R¹—N—C(R³)—N—R²]Li+LiX (2)

The third step is represented by the following reaction formula (3).

n{[R¹—N—C(R³)—N—R²]Li+LiX}+MXn→[R¹—N—C(R³)—N—R²]nM+nLiX+nLiX-tm (3)

In the above reaction formulas (2) and (3), the by-product LiX was normally removed. The reason is as follows. Namely, it has been conceived that the by-product LiX generated in the reaction of the preliminary performed steps (1) and (2) inhibits the subsequent reaction.

As per the reaction formulas (2) and (3) being represented by the following formulas of (2-1) and (3-1), the by-product LiX was normally removed.

Normally, the by-product LiX generated in the reaction [formula (1)] as the first step was removed prior to the second step (reaction).

Normally, the by-product LiX generated in the reaction [formula (2)] as the second step was removed prior to the third step (reaction).

This is troublesome.

To solve the above problem, in the present invention, the by-product LiX generated in the first step is not removed prior to the second step (reaction). Further, the by-product LiX generated in the second step is not removed prior to the third step (reaction). This provides good workability.

R³Li+R¹—N═C═N—R²→[R¹—N—C(R³)—N—R²]Li (2-1)

n[R¹—N—C(R³)—N—R²]Li+MXn→[R¹—N—C(R³)—N—R²]nM+nLiX (3-1)

Preferably, the second step is performed in a state where the LiX is substantially left in the solution obtained by the first step. Further preferably, the second step is performed without performing the process for removing the LiX from the solution obtained by the first step (i.e., the second step is performed in a state where the LiX is left in the solution obtained by the first step). Specially preferably, the second step is performed without performing the process for removing the LiX from the solution obtained by the first step at all (i.e., the second step is performed in a state where the LiX is left in the solution obtained by the first step). This makes the process simple. Because the removal of the LiX is not performed, the complicated process can be eliminated. There was no hindrance when the second step (reaction) was performed even when the LiX was not removed.

Preferably, the third step is performed in a state where the LiX is substantially left in the solution obtained by the second step. Further preferably, the third step is performed without performing the process for removing the LiX from the solution obtained by the second step (i.e., the third step is performed in a state where the LiX is left in the solution obtained by the second step). Specially preferably, the third step is performed without performing the process for removing the LiX from the solution obtained by the second step (i.e., the third step is performed in a state where the LiX is left in the solution obtained by the second step). This makes the process simple. Because the removal of the LiX is not performed, the complicated process can be eliminated. There was no hindrance when the third step (reaction) was performed even when the LiX was not removed.

The solvent in the solution obtained by the third step is replaced by a hydrocarbon-based solvent to perform the removal of the LiX. The hydrocarbon-based solvent is, for example, n-hexane. The removal of the LiX is performed by one or two or more operations selected from the group consisting of filtration, centrifugal separation, decantation, and distillation.

The process from the first step to the third step is performed in the same container. More specifically, the entire process from the first step to the third step is performed in the same reaction container (reaction oven). This makes the process simple.

R¹—N═C═N—R² used in the second step is, for example, N, N′-diisopropyl carbodiimide, or N, N′-di-tert-butylcarbodiimide.

The MX used in the third step is, for example, YCl₃, MnCl₂, FeCl₂, CoCl₂, NiCl₂, CuCl, AgCl, YBr₃, MnBr₂, FeBr₂, CoBr₂, NiBr₂, CuBr, AgBr, YI₃, MnI₂, FeI₂, CoI₂, NiI₂, CuI, or AgI.

Hereinafter, specific examples are described. The present invention, however, is not limited to those examples. It is to be understood that various modification examples and application examples will be embraced within the scope of the present invention unless otherwise the characteristics of the present invention degrade largely.

### Example 1

[bis(N, N′-diisopropylpropion amidinate)cobalt]

Reaction was performed under an inert gas atmosphere. Into a flask containing 0.4 mol lithium and 250 ml diethyl ether, ethyl chloride of 0.2 mol was dropped slowly. The ethyl chloride was in a state of liquid by being cooled. The lithium chloride (by-product: insoluble matter; white solid) generated in the progress of the reaction was suspended. After the dropping, the lithium was completely consumed. N, N′-diisopropyl carbodiimide of 0.2 mol was slowly dropped into the suspension. Reaction heat occurred to reflux the diethyl ether. Agitation was performed at room temperature for four hours. Cobalt chloride (CoCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Distillation under reduced pressure (0.1 torr) was performed. A yield of thus obtained bis(N, N′-diisopropylpropion amidinate)cobalt was about 90%.

In the above-described process, after the Li was completely consumed, the N, N′-diisopropylcarbodiimide was dropped. There was no problem even when the N, N′-diisopropylcarbodiimide was dropped in a state where a little Li was left.

### Example 2

[bis(N, N′-diisopropylbutaneamidinate)cobalt]

Reaction was performed under an inert gas atmosphere. Into a flask containing 0.4 mol lithium and 250 ml diethyl ether, n-propyl chloride of 0.2 mol was dropped slowly. The lithium chloride (by product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Cobalt chloride (CoCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Distillation under reduced pressure (0.1 torr) was performed. A yield of thus obtained bis(N, N′-diisopropylbutaneamidinate)cobalt was about 89%.

### Example 3

[bis(N, N′-diisopropylbutaneamidinate)cobalt]

Reaction was performed under an inert gas atmosphere. Into a flask containing 0.4 mol lithium and 250 ml diethyl ether, n-propyl bromide of 0.2 mol was dropped slowly. Lithium bromide (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Cobalt chloride (CoCl₂) of 0.1 mol was added to the suspended reaction mixture. Reaction heat occurred to reflex the diethyl ether. Agitation was performed for 24 hours. In the above-described process, removal of the lithium bromide (by-product) was not performed at all. All the reactions in the above-described process were performed in the same flask. A solvent was distilled away. N-hexane of 500 ml was added thereto. The lithium bromide and the lithium chloride (both are insoluble matters) are obtained via filtration. The solvent was distilled away. Distillation under reduced pressure (0.1 torr) was performed. A yield of thus obtained bis(N, N′-diisopropylbutaneamidinate)cobalt was about 53%.

### Example 4

[bis(N-N′-di-tert-butylbutaneamidinate)cobalt]

Reaction was performed under an inert gas atmosphere. Into a flask containing 0.4 mol lithium and 250 ml diethyl ether, n-propyl chloride of 0.2 mol was dropped slowly. The lithium chloride (by-product: insoluble matter: white solid) generated with the progress of the reaction was suspended. After the dropping, the lithium was completely consumed. N, N′-di-tert-butylcarbodiimide of 0.2 mol was slowly dropped into the suspension solution. Reaction heat occurred to reflux the diethyl ether. Agitation was performed at room temperature for four hours. Cobalt chloride (CoCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Sublimation under reduced pressure (0.1 torr) was performed. A yield of thus obtained bis(N, N′-di-tert-butylbutaneamidinate)cobalt was about 35%.

### Example 5

[bis(N, N′-diisopropylpropionamidinate)iron]

Reaction was performed under an inert gas atmosphere. Into a flask containing 0.4 mol lithium and 250 ml diethyl ether, ethyl chloride of 0.2 mol was dropped slowly. The ethyl chloride was in a state of liquid by being cooled. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Iron chloride (FeCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was removed via decantation. The solvent was distilled away. Distillation under reduced pressure (0.1 torr) was performed. A yield of thus obtained bis(N, N′-diisopropylpropionamidinate)iron was about 92%.

### Example 6

[bis(N, N′-diisopropylbutaneamidinate)iron]

Reaction was performed under an inert gas atmosphere. Into a flask containing 0.4 mol lithium and 250 ml diethyl ether, n-propyl chloride of 0.2 mol was dropped slowly. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Iron chloride (FeCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Distillation under reduced pressure (0.1 torr) was performed. A yield of thus obtained bis(N, N′-diisopropylbutaneamidinate)iron was about 91%.

### Example 7

[bis(N, N′-diisopropylpropionamidinate)manganese]

Reaction was performed under an inert gas atmosphere. Into a flask containing 0.4 mol lithium and 250 ml diethyl ether, ethyl chloride of 0.2 mol was dropped slowly. The ethyl chloride was in a state of liquid by being cooled. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Mangan chloride (MnCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Distillation under reduced pressure (0.1 torr) was performed. A yield of thus obtained bis(N, N′-diisopropylpropionamidinate)manganese was about 70%.

### Example 8

[bis(N, N′-diisopropylbutaneamidinate)manganese]

Reaction was performed under an inert gas atmosphere. Into a flask containing 0.4 mol lithium and 250 ml diethyl ether, n-propyl chloride of 0.2 mol was dropped slowly. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflex the diethyl ether. Agitation was performed at room temperature for four hours. Manganese chloride (MnCl₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Distillation under reduced pressure (0.1 torr) was performed. A yield of thus obtained bis(N, N′-diisopropylbutaneamidinate)manganese was about 76%.

### Example 9

[bis(N, N′-diisopropylpropionamidinate)magnesium]

Reaction was performed under an inert gas atmosphere. Into a flask containing 0.4 mol lithium and 250 ml diethyl ether, ethyl chloride of 0.2 mol was dropped slowly. The ethyl chloride was in a state of liquid by being cooled. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Magnesium bromide (MgBr₂) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. By distillation under reduced pressure (0.1 torr) , bis(N, N′-diisopropylpropionamidinate)magnesium was separated from the lithium chloride and the lithium bromide. A yield of thus obtained bis(N, N′-diisopropylpropionamidinate)magnesium was about 63%.

### Example 10

[bis(N, N′-diisopropylbutaneamidinate)magnesium]

Reaction was performed under an inert gas atmosphere. Into a flask containing 0.4 mol lithium and 250 ml diethyl ether, n-propyl chloride of 0.2 mol was dropped slowly. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Magnesium bromide (MgBr₂) of 0.1 mol was added to the suspended reaction mixture. Reaction heat occurred to reflux the diethyl ether. Agitation was performed for 24 hours. In the above-described process, removal of the lithium chloride and the lithium bromide (both are by-products) was not performed at all. All the reactions in the above-described process were performed in the same flask. A solvent was distilled away. N-hexane of 500 ml was added thereto. The lithium chloride and the lithium bromide (both are insoluble matters) were obtained via filtration. The solvent was distilled away. Distillation under reduced pressure (0.1 torr) was performed. A yield of thus obtained bis(N, N′-diisopropylbutaneamidinate)magnesium was about 79%.

### Example 11

[bis(N, N′-di-isopropylbutaneamidinate)nickel]

Reaction was performed under an inert gas atmosphere. Into a flask containing 0.4 mol lithium and 250 ml diethyl ether, n-propyl chloride of 0.2 mol was dropped slowly. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. A nickel chloride dimethoxyethane adduct (NiCl₂·DME) of 0.1 mol was added into the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Then, distillation under reduced pressure (0.1 torr) was performed. A yield of thus obtained bis(N, N′-diisopropylbutaneamidinate)nickel was about 80%.

### Example 12

[(N, N′-diisopropylpropionamidinatecopper)₂]

Reaction was performed under an inert gas atmosphere. Into a flask containing 0.4 mol lithium and 250 ml diethyl ether, ethyl chloride of 0.2 mol was dropped slowly. The ethyl chloride was in a state of liquid by being cooled. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Copper chloride (CuCl) of 0.2 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. Lithium chloride (insoluble matter) of 0.4 mol was obtained via filtration. The solvent was distilled away. Sublimation under reduced pressure (0.1 torr) was performed. A yield of the (N, N′-diisopropylpropionamidinatecopper)₂ as thus obtained dimer was about 50%.

### Example 13

[(N, N′-diisopropylpropionamidinatesilver)₂]

Reaction was performed under an inert gas atmosphere. Into a flask containing 0.4 mol lithium and 250 ml diethyl ether, ethyl chloride of 0.2 mol was dropped slowly. The ethyl chloride was in a state of liquid by being cooled. The lithium chloride (by-product: insoluble matter: white solid) generated with the progress of the reaction was suspended. After the dropping, the lithium was completely consumed. N, N′-diisopropylcarbodiimide of 0.2 mol was slowly dropped into the suspension solution. Reaction heat occurred to reflux the diethyl ether. Agitation was performed at room temperature for four hours. Silver bromide (AgBr) of 0.2 mol was added to the suspended reaction mixture. Reaction heat occurred to reflux the diethyl ether. Agitation was performed for 24 hours. In the above-described process, removal of the lithium chloride and the lithium bromide (both are insoluble matters) was not performed at all. All the reactions in the above-described process were performed in the same flask. A solvent was distilled away. N-hexane of 500 ml was added thereto. The lithium chloride (insoluble matter) of 0.4 mol was obtained via filtration. The solvent was distilled away. Sublimation under reduced pressure (0.1 torr) was performed. A yield of the (N, N′-diisopropylpropionamidinatesilver)₂ as thus obtained dimer was about 53%.

### Example 14

[tris(N, N′-diisopropylpropionamidinate)yttrium]

Reaction was performed under an inert gas atmosphere. Into a flask containing 0.6 mol lithium and 300 ml diethyl ether, ethyl chloride of 0.3 mol was dropped slowly. The ethyl chloride was in a state of liquid by being cooled. The lithium chloride (by-product: insoluble matter: white solid) generated with the progress of the reaction was suspended. After the dropping, the lithium was completely consumed. N, N′-diisopropylcarbodiimide of 0.3 mol was slowly dropped into the suspension solution. Reaction heat occurred to reflux the diethyl ether. Agitation was performed at room temperature for four hours. Yttrium chloride (YCl₃) of 0.1 mol was added to the suspended reaction mixture. Reaction heat occurred to reflux the diethyl ether. Agitation was performed for 24 hours. In the above-described process, removal of the lithium chloride (by-product) was not performed at all. All the reactions in the above-described process were performed in the same flask. A solvent was distilled away. N-hexane of 500 ml was added thereto. The lithium chloride (insoluble matter) of 0.6 mol was obtained via filtration. The solvent was distilled away. Sublimation under reduced pressure (0.1 torr) was performed. A yield of thus obtained tris(N, N′-diisopropylpropionamidinate)yttrium was about 55%.

1. A method for producing an amidinate metal complex {[R¹—N—C(R³)—N—R²]nM (where the R¹ and the R² are an alkyl group whose carbon number is 2 to 4 or an alkyl group having Si whose carbon number is 2 to 4; where the R³ is —C₂H₅ or —C₃H₇; where the n is 2 or 3; and where the M is Mg, Ca, V, Cr, Mn, Fe, Co, Ni, Cu, Ag, or Ru)}:
wherein R³X is reacted with a metal Li in a solvent to obtain a R³Li solution with LiX suspended therein, R³Li in the solution with the LiX existing therein is reacted with R¹—N═C═N—R² to obtain a [R¹—N—C(R³)—N—R²]Li solution with the LiX suspended therein, the [R¹—N—C(R³)—N—R²]Li in a solution with the LiX existing therein is reacted with MX to obtain a [R¹—N—C(R.³)—N—R²]nM solution with the LiX suspended therein, and thereafter the LiX (where the X is Cl, Br, or I; and where the X of the LiX may be the same as or different from the X of the MX) in the [R¹—N—C(R³)—N—R²]nM solution is removed.

2. The method for producing an amidinate metal complex according to claim 1, wherein the reaction of the R³Li with the R¹—N═C═N—R² is performed in a state where the LiX is substantially left in the R³Li solution.

3. The method for producing an amidinate metal complex according to claim 1, wherein the reaction of the [R¹—N—C(R³)—N—R²]Li with the MX is performed in a state where the LiX is substantially left in the [R¹—N—C(R³)—N—R²]Li solution.

4. The method for producing an amidinate metal complex according to claim 1, wherein the removal of the LiX in the [R¹—N—C(R³)—N—R²]nM solution is performed in such a manner that the solvent in the [R¹—N—C(R³)—N—R²]nM solution is replaced by a hydrocarbon-based solvent.

5. The method for producing an amidinate metal complex according to claim 1, wherein the removal of the LiX is performed by one or two or more operations selected from the group consisting of filtration, centrifugal separation, decantation, and distillation.

6. The method for producing an amidinate metal complex according to claim 1, wherein the reaction from the generation of the R³Li to the generation of [R¹—N—C(R³)—N—R²]nM is performed in the same container.

7. The method for producing an amidinate metal complex according to claim 1, wherein the R¹—N═C═N—R² is N, N′-diisopropylcarbodiimide or N, N′-di-tert-butylcarbodiimide.

8. The method for producing an amidinate metal complex according to claim 1, wherein the MX is at least one chemical compound selected from the group consisting of YCl₃, MnCl₂, FeCl₂, CoCl₂, NiCl₂, CuCl, AgCl, YBr₃, MnBr₂, FeBr₂, CoBr₂, NiBr₂, CuBr, AgBr, YI₃, MnI₂, FeI₂, CoI₂, NiI₂, Cut, and AgI.

9. The method for producing an amidinate metal complex according to claim 1, wherein the [R¹—N—C(R³)—N—R²]nM is a chemical compound used for depositing a M-based film.
